(19) United States
(12) Patent Application Publication
(10) Pub. No.: US 2006/0065080 A1
(43) Pub. Date: Mar. 30, 2006

(54) Ratcheting tools

(76) Inventors: John B. Davidson, Chicago, IL (US); George F. Charvat, Lombard, IL (US)

Correspondence Address: BRINKS HOFER GILSON & LIONE, P.O. BOX 10395, CHICAGO, IL, 60610, US

(21) Appl. No.: 10/953,470

(22) Filed: Sep. 28, 2004

(51) Int. Cl. B25B 13/46

(52) U.S. Cl. 81/63

(57) ABSTRACT

Ratcheting tools are described that include: (a) a tool body; (b) a driven element; (c) a ratchet mechanism coupling the driven element to the tool body, wherein the ratchet mechanism is configured for adjustment between a plurality of a forward configuration, a reverse configuration, and a neutral configuration; (d) an adjustable first biasing element coupled to the ratchet mechanism and configured to bias the ratchet mechanism to at least one of the forward, reverse, and neutral configurations; and (e) an adjustable second biasing element coupled to the ratchet mechanism and configured to bias the ratchet mechanism to at least one of the forward, reverse, and neutral configurations.

### FIELD OF THE INVENTION

The present invention relates to hand tools and, in particular, to ratcheting hand tools configured for providing forward ratcheting action, reverse ratcheting action, and neutral or non-ratcheting action.

### BACKGROUND

Hand tools capable of providing clockwise (e.g., forward) ratcheting action, counterclockwise (e.g., reverse) ratcheting action, and freewheeling (e.g., neutral or non-ratcheting) action provide advantages in use because a user is not required to reposition his or her hand on a handle multiple times in order to provide continuous rotation in a selected direction.

In the hand tools described in U.S. Pat. No. 6,182,536 to Roberts et al., assigned to the assignee of the present invention, the position of a pivotably mounted pawl 34 having first, second, and third depressions therein corresponding to forward, neutral, and reverse ratcheting actions of the hand tool, respectively, is controlled by a single spring 42. Whichever of the three depressions is engaged by spring 42 determines the direction of ratcheting action.

In the hand tools described in U.S. Pat. No. 6,044,730 to Roberts et al., also assigned to the assignee of the present invention, the position of a reversing lever 18 movable between forward, neutral, and reverse positions is controlled by a detent mechanism in which a single spring-loaded detent ball engages one of forward detent recess 23, reverse detent recess 24, and non-ratcheting detent recess 22 in a pawl 25.

Although the above-described ratcheting tools are well-suited for a variety of applications, it would be desirable in certain applications to increase the stability of the neutral position in order to minimize or prevent inadvertent slippage info either of the forward or reverse ratcheting positions.

### SUMMARY

The scope of the present invention is defined solely by the appended claims, and is not affected to any degree by the statements within this summary.

By way of introduction, a first ratcheting tool embodying features of the present invention includes: (a) a tool body; (b) a driven element; (c) a ratchet mechanism coupling the driven element to the tool body, wherein the ratchet mechanism is configured for adjustment between a plurality of a forward configuration, a reverse configuration, and a neutral configuration; (d) an adjustable first biasing element coupled to the ratchet mechanism and configured to bias the ratchet mechanism to at least one of the forward, reverse, and neutral configurations; and (e) an adjustable second biasing element coupled to the ratchet mechanism and configured to bias the ratchet mechanism to at least one of the forward, reverse, and neutral configurations.

A second ratcheting tool embodying features of the present invention includes: (a) a tool body; (b) a driven element containing a drive stud; (c) a ratchet mechanism coupling the driven element to the tool body, wherein the ratchet mechanism is configured for adjustment between a forward configuration, a reverse configuration, and a neutral configuration; (d) a first biasing element coupled to the ratchet mechanism and configured to bias the ratchet mechanism to at least one of the forward, neutral, and reverse configurations; (e) a second biasing element coupled to the ratchet mechanism and configured to bias the ratchet mechanism to at least one of the forward, neutral, and reverse configurations; (f) a control element coupled to the ratchet mechanism and containing first, second and third outwardly facing notches, each of which is configured to engage with the second biasing element, such that engagement of the first notch biases the ratchet mechanism to the forward configuration, engagement of the second notch biases the ratchet mechanism to the neutral configuration, and engagement of the third notch biases the ratchet mechanism to the reverse configuration; and (g) a control element retainer coupled to the control element, wherein the control element retainer contains an arcuate recess configured to receive the second biasing element. The ratchet mechanism includes a toothed element and a pawl configured to engage the toothed element.

A third ratcheting tool embodying features of the present invention includes: (a) a tool body; (b) a driven element comprising a drive stud; (c) a ratchet mechanism coupling the driven element to the tool body, wherein the ratchet mechanism is configured for adjustment between a forward configuration, a reverse configuration, and a neutral configuration; (d) a first biasing element coupled to the ratchet mechanism and configured to bias the ratchet mechanism to at least one of the forward, neutral, and reverse configurations; (e) a second biasing element coupled to the ratchet mechanism and configured to bias the ratchet mechanism to at least one of the forward, neutral, and reverse configurations; (f) a control element coupled to the ratchet mechanism, wherein the control element includes a recess configured to receive the second biasing element; and (g) a control element retainer containing first, second and third notches, each of which is configured to engage with the second biasing element, such that engagement of the first notch biases the ratchet mechanism to the forward configuration, engagement of the second notch biases the ratchet mechanism to the neutral configuration, and engagement of the third notch biases the ratchet mechanism to the reverse configuration. The ratchet mechanism includes a toothed element and a pawl configured to engage the toothed element.

A fourth ratcheting tool embodying features of the present invention includes: (a) a tool body; (b) a driven element; (c) a ratchet mechanism coupling the driven element to the tool body, wherein the ratchet mechanism is configured for adjustment between a plurality of a forward configuration, a reverse configuration, and a neutral configuration; (d) an adjustable first biasing element coupled to the ratchet mechanism and configured to bias the ratchet mechanism to at least one of the forward, reverse, and neutral configurations; and (e) an adjustable second biasing element coupled to the ratchet mechanism and configured to bias the ratchet mechanism to at least one of the forward, reverse, and neutral configurations. At least one of the first biasing element and the second biasing element is configured to bias the ratchet mechanism to the neutral configuration.

### BRIEF DESCRIPTION OF THE DRAWINGS

FIG. 1 shows an elevation view of a first ratcheting tool embodying features of the present invention.

FIG. 2 shows an exploded perspective view of the ratcheting tool shown in FIG. 1.

FIG. 3A shows a side elevation view of a tool body.

FIG. 3B shows a top plan view of the tool body of FIG. 3A.

FIG. 3C shows a bottom view of the tool body of FIG. 3A.

FIG. 3D shows a cross-sectional view of the tool body of FIG. 3A taken through a plane containing the line 3D-3D.

FIG. 4A shows a side elevation view of a driven element.

FIG. 4B shows a top plan view of the driven element of FIG. 4A shown from a drive stud end.

FIG. 4C shows a cross-sectional view of the driven element of FIG. 4A taken through a plane containing the line 4C-4C.

FIG. 5A shows a side elevation view of a tool body extension.

FIG. 5B shows a top plan view of a toothed element provided on an inner surface of the tool body extension of FIG. 5A.

FIG. 5C shows a bottom view of the tool body extension of FIG. 5A.

FIG. 5D shows a cross-sectional view of the tool body extension of FIG. 5A taken through a plane containing the line 5D-5D.

FIG. 6A shows an elevation view of a key element.

FIG. 6B shows a side elevation view of the key element of FIG. 6A.

FIG. 6C shows a top plan view of the key element of FIG. 6A.

FIG. 7A shows a top plan view of a pawl carrier.

FIG. 7B shows a cross-sectional view of the pawl carrier of FIG. 7A taken through a plane containing the line 7B-7B.

FIG. 8A shows a top plan view of a pawl.

FIG. 8B shows a side elevation view of the pawl of FIG. 8A.

FIG. 9A shows a side elevation view of a pin.

FIG. 9B shows a top plan view of the pin of FIG. 9A.

FIG. 9C shows a cross-sectional view of the pin of FIG. 9A taken through a plane containing the line 9C-9C.

FIG. 10A shows a side elevation view of a post.

FIG. 10B shows a top plan view of the post of FIG. 10A.

FIG. 11A shows a top plan view of a spring.

FIG. 11B shows side elevation view of the spring of FIG. 11A.

FIG. 12A shows a side elevation view of a first control element.

FIG. 12B shows a top plan view of the control element of FIG. 12A.

FIG. 12C shows a bottom view of the control element of FIG. 12A.

FIG. 12D shows a cross-sectional view of the control element of FIG. 12A taken through a plane containing the line 12D-12D.

FIG. 13A shows a side elevation view of a first control element retainer.

FIG. 13B shows a top plan view of the control element retainer of FIG. 13A.

FIG. 13C shows a bottom view of the control element retainer of FIG. 13A.

FIG. 13D shows a cross-sectional view of the control element retainer of FIG. 13A taken through a plane containing the line 13D-13D.

FIG. 14 shows a top plan view of a spring configured for placement in the control element retainer of FIG. 13A.

FIG. 15A shows an elevation view of a second ratcheting tool embodying features of the present invention.

FIG. 15B shows a cross-sectional view of the ratcheting tool of FIG. 15A taken at a right angle to the longitudinal axis through a plane containing the line 15B-15B.

FIG. 15C shows a cross-sectional view of the ratcheting tool of FIG. 15A taken at a right angle to the longitudinal axis through a plane containing the line 15C-15C.

FIG. 15D shows a cross-sectional view of the ratcheting tool of FIG. 15A taken at a right angle to the longitudinal axis through a plane containing the line 15D-15D.

FIG. 16A shows a top plan view of a second control element.

FIG. 16B shows a bottom view of the control element of FIG. 16A.

FIG. 16C shows a cross-sectional view of the control element of FIG. 16A taken through a plane containing the line 16C-16C.

FIG. 17A shows a top plan view of a second control element retainer.

FIG. 17B shows a bottom view the control element retainer of FIG. 17A.

FIG. 17C shows a cross-sectional view of the control element retainer of FIG. 17A taken through a plane containing the line 17C-17C.

FIG. 18A shows a top plan view of a bottom pawl support for use a third ratcheting tool embodying features of the present invention.

FIG. 18B shows a bottom view of the pawl support of FIG. 18A.

FIG. 19A shows a front perspective view of a fourth ratcheting tool embodying features of the present invention in a first ratcheting configuration.

FIG. 19B shows a perspective view of the ratcheting tool of FIG. 19A in a second ratcheting configuration.

FIG. 19C shows a perspective view of the ratcheting tool of FIG. 19A in a non-ratcheting configuration.

FIG. 19D shows a side perspective view of the ratcheting tool of FIG. 19C.

### DETAILED DESCRIPTION

Ratcheting tools have been discovered and are described below that provide forward ratcheting action, reverse ratcheting action, and neutral (i.e., freewheeling or non-ratcheting) action, wherein the stability of the neutral position is significantly improved as compared to previous designs, and wherein forces acting at different positions of the tool may be independently adjusted using separate biasing mechanisms. In some embodiments, as further described below, the ratcheting tools embodying features of the present invention include a plurality (i.e., two or more) biasing elements (e.g., springs, spring-loaded detent balls, and the like, and combinations thereof, at least one of which is configured for biasing the ratchet mechanism to at least the neutral position.

In some embodiments, a first biasing element biases the ratchet mechanism to either the forward or reverse configuration while a second biasing element biases the ratchet mechanism to the neutral position. In other embodiments, a first biasing element biases the ratchet mechanism to either the forward, neutral or reverse configuration while a second biasing element biases the ratchet mechanism to the neutral position. In other embodiments, a first biasing element biases the ratchet mechanism to either the forward, neutral or reverse configuration while a second biasing element acts in concert with the first biasing element to further bias the ratchet mechanism to the desired configuration.

Throughout this description and in the appended claims, the following definitions are to be understood:

The term “coupled” is intended broadly to encompass both direct and indirect coupling. Thus, first and second parts are said to be coupled together when they are directly connected and/or functionally engaged (e.g. by direct contact), as well as when the first part is functionally engaged with an intermediate part which is functionally engaged either directly or via one or more additional intermediate parts with the second part. Also, two elements are said to be coupled when they are functionally engaged (directly or indirectly) at some times and not functionally engaged at other times.

The phrase “biasing element” refers to any device that can be moved and/or reversibly deformed, such that the movement and/or deformation provides a biasing force against a member mechanically coupled thereto. Representative biasing elements include but are not limited to springs (e.g., elastomeric torsion springs, coil springs, leaf springs, tension springs, compression springs, spiral springs, volute springs, flat springs, and the like), detents (e.g., spring-loaded detent balls, cones, wedges, and the like), pneumatic devices, hydraulic devices, and the like, and combinations thereof.

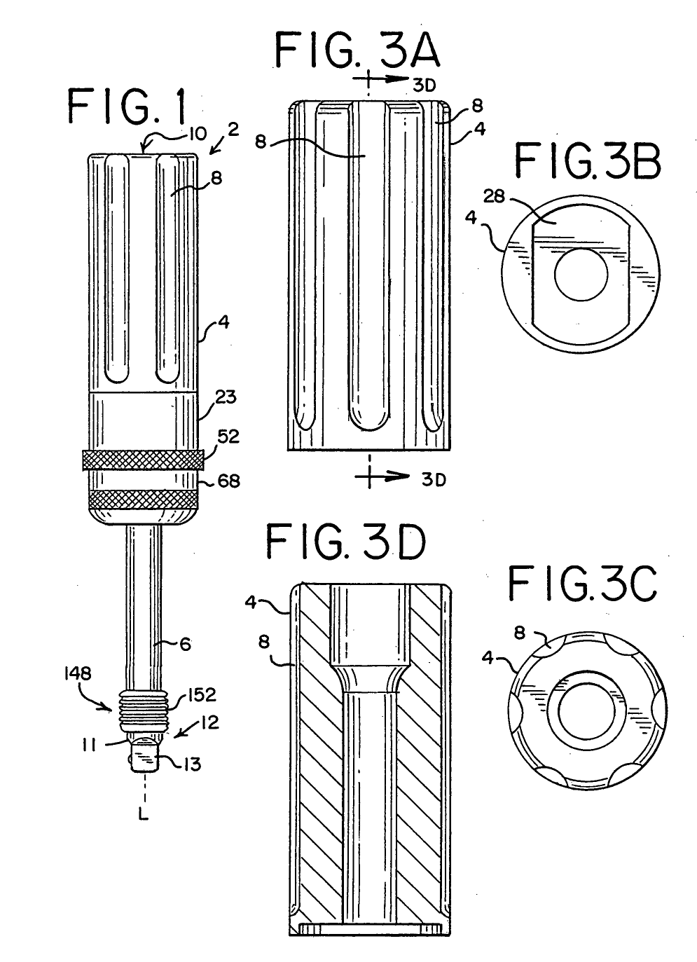

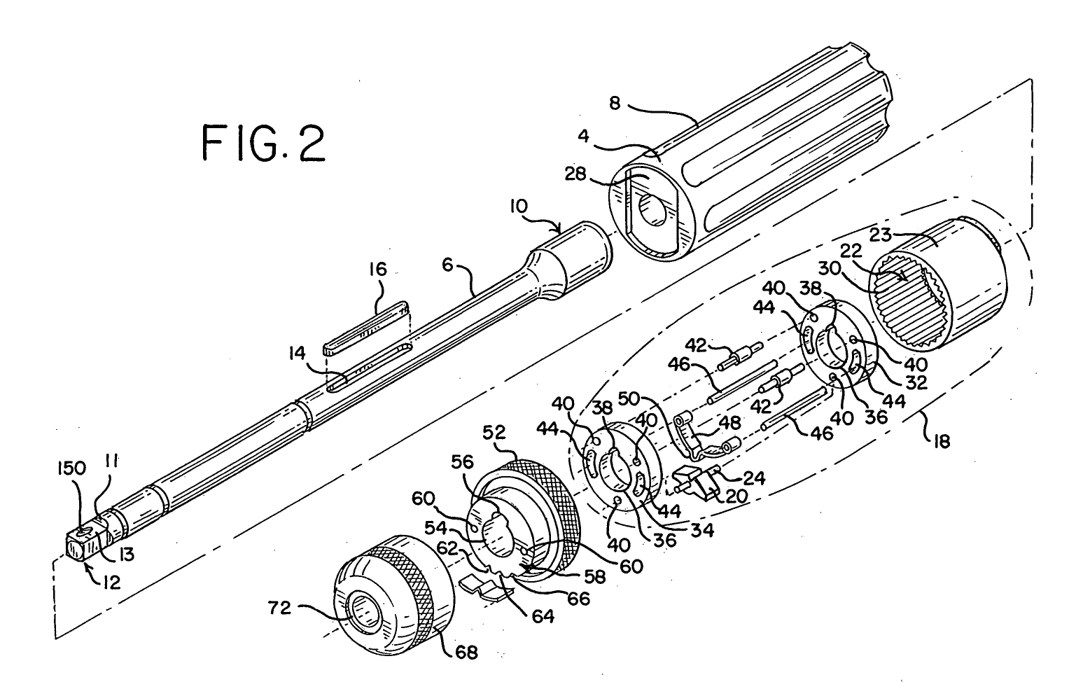

The designations “top” and “bottom” used in reference to elements shown in the drawings are applied merely for convenience of description. These designations are not to be construed as absolute or limiting and may be reversed. For the sake of clarity, unless otherwise noted, the term “top” generally refers to the side of an element that faces away from the tool body end of a ratcheting tool in its assembled state (e.g., towards the drive stud end in the representative depiction shown in FIGS. 1-2). In addition, unless otherwise noted, the term “bottom” generally refers to the side of an element that faces towards the end of the ratcheting tool opposite the drive stud.

The designations “inwardly facing” and “outwardly facing” used in reference to various elements (e.g., the teeth of a toothed element, the sides of a cavity including any notch) are likewise applied merely for convenience of description. These designations are not to be construed as absolute or limiting and may be reversed. For the sake of clarity, unless otherwise noted, the phrase “inwardly facing” generally refers to an orientation towards the central axis of a ratcheting tool (such as, for example, the axis that runs the length of the driven element). In addition, unless otherwise noted, the phrase “outwardly facing” generally refers to orientation away from the central axis of the ratcheting tool and towards the outer exposed surface of the tool body. As used in reference to notches, orientation towards and away from the central axis is determined relative to the concave opening of the notch.

The terms “forward” and “reverse” used in reference to directions of ratcheting action generally refer to first and second opposing ratcheting directions. Technically speaking, these terms should be understood in reference to the drive stud end of the ratcheting tool, such that “forward” corresponds to a clockwise transmittal of torque at the drive stud end and “reverse” corresponds to a counterclockwise transmittal of torque at the drive stud end. However, unless context dictates otherwise, these terms are used interchangeably herein provided it is understood that the absolute directions of rotation to which they refer oppose each other.

The phrase “extension bar” is intended broadly to encompass any structure with a first coupling element at one end (e.g., a socket, a drive stud, etc.), a second coupling element (e.g., a socket, a drive stud, etc.) at the other end, and at least one torque-transmitting element therebetween. Representative extension bars may include additional elements such as universal joints, and the like.

The term “handle” refers to any element coupled to and/or integral with a ratcheting tool that is configured to be held by a user thereof. In some embodiments, the tool body of the ratcheting tool provides the handle and in other embodiments, the driven element of the ratcheting tool provides the handle. In some embodiments, the handle is provided by a separate attachment coupled to some portion of the ratcheting tool (e.g., the tool body, either end of the driven element, etc.) at any angle to the longitudinal axis of the ratcheting tool (e.g., collinear with, at right angles to, or at skew angles to the longitudinal axis). It is to be understood that handles provided as separate attachments may be used with any of the ratcheting tools described herein.

Ratcheting tools embodying features of the present invention include a tool body; a driven element; a ratchet mechanism coupling the driven element to the tool body, wherein the ratchet mechanism is configured for adjustment between a plurality of a forward configuration, a reverse configuration, and a neutral configuration; an adjustable first biasing element coupled to the ratchet mechanism and configured to bias the ratchet mechanism to at least one of the forward, reverse, and neutral configurations; and an adjustable second biasing element coupled to the ratchet mechanism and configured to bias the ratchet mechanism to at least one of the forward, reverse, and neutral configurations.

In some embodiments further described below, the first and second biasing elements are configured to act in concert to provide the same type of bias to the ratchet mechanism, such that both the first and second biasing elements simultaneously provide a common bias towards at least one of the forward, reverse, and neutral configurations.

Representative embodiments in accordance with the present invention will now be described in reference to the appended drawings. It is to be understood that elements and features of the various representative embodiments described below may be selected or combined in different ways to produce additional embodiments that likewise fall within the scope of the present invention. Accordingly, the description provided below, when provided in reference to one or more specific figures, is to be understood as being likewise applicable to other embodiments, including but not limited to those shown in other drawing figures whether or not they are specifically referenced.

FIGS. 1 and 2 show a first ratcheting tool 2 embodying features of the present invention. The ratcheting tool 2 includes a tool body 4 and a longitudinally extending driven element 6. The tool body 4, best shown by FIGS. 3A-3D, is mounted around driven element 6 and is freely rotatable thereabout. In some embodiments, tool body 4 includes one or more grooves 8, as shown in FIG. 3A, or other features (e.g., knurling, non-slip textured materials formed around the tool body or applied by adhesives or other means, and the like) in order to provide a comfortable gripping surface.

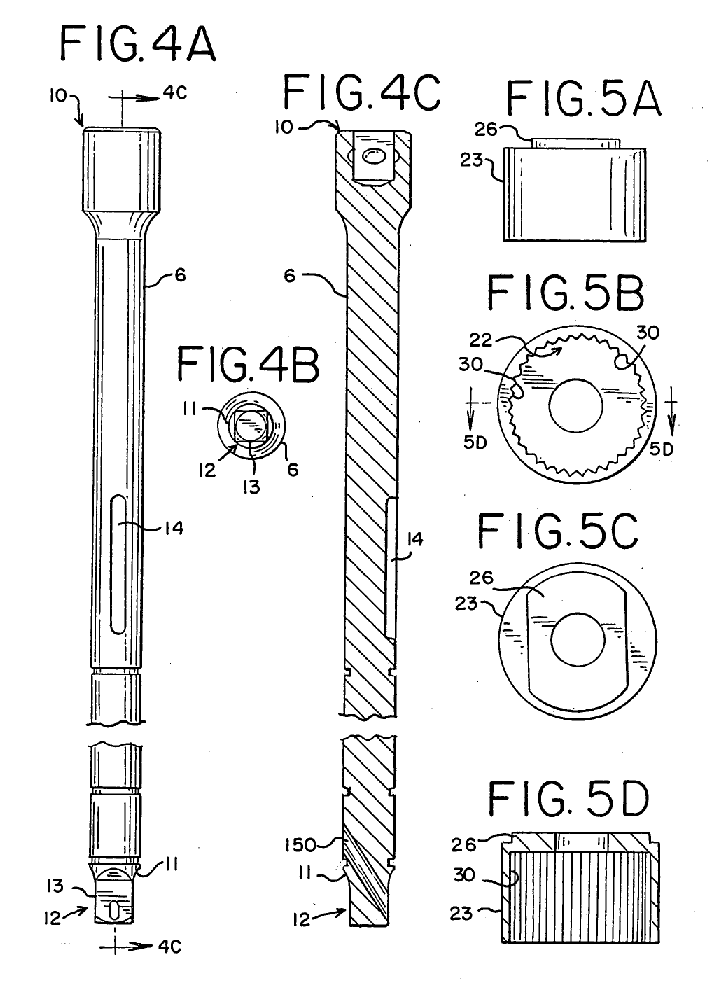

The driven element 6 may be an extension bar containing a first coupling end (e.g., male or female) and a second coupling end (e.g., male or female). By way of example, the driven element 6 may be an extension bar containing a socket 10 and a drive stud 12 provided on opposite ends thereof, as best shown by FIGS. 4A-4C. However, any element to be turned or driven by a ratcheting or freewheeling action has been contemplated for use in accordance with the present invention. In some embodiments, driven element 6 is a continuous, solid element from end to end while in others, driven element 6 is partially or substantially hollowed. In the neutral position, tool body 4 may be used to steady driven element 6 while driven element 6 is rotated by a tool such as a socket wrench (not shown) engaged with socket 10.

The socket 10 is formed with a usually out-of-round cross section which may, for example, be square, hexagonal or the like. Socket 10 is configured to receive the drive stud of a socket wrench (not shown) or other drive tool when the socket wrench or other tool is used to apply torque to driven element 6. The drive stud 12 includes a usually out-of-round drive portion 13 and an adjacent portion 11. The drive portion 13 is shaped to fit within a tool attachment (not shown) to apply torque to the tool attachment. The out-of-round drive portion 13 may be provided with any desired cross-sectional shape and may, for example, be generally square or hexagonal in cross section. The driven element 6 and the outer portion of socket 10 may be substantially rotationally symmetrical about a longitudinal axis L.

As best shown by FIGS. 4A and 4C, driven element 6 includes a recessed cavity 14 in an intermediate portion thereof, which is configured to receive a key element 16 that has a shape and dimensions complementary thereto. A representative key element 16, best shown by FIGS. 6A-6C, is further described below.

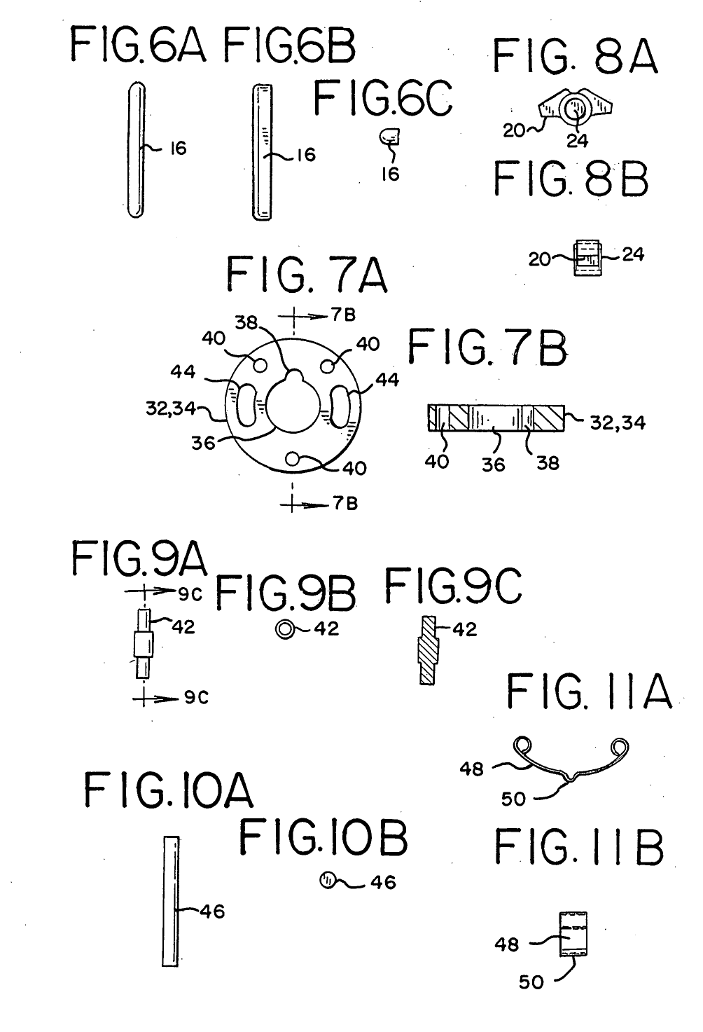

The ratcheting tool 2 shown in FIGS. 1 and 2 further includes a ratchet mechanism 18 that couples driven element 6 to tool body 4. The ratchet mechanism 18 is configured for adjustment between a plurality (i.e., at least two) of a forward configuration, a reverse configuration, and a neutral configuration wherein the tool body 4 is allowed to free-wheel with respect to driven element 6. In some embodiments, ratchet mechanism 18 includes a pivotably mounted pawl 20, best shown by FIGS. 8A and 8B, and a toothed element 22, best shown by FIGS. 5A-5D. The toothed element 22 may be provided by and/or supported on an inner surface of a tool body extension 23, as best shown by FIG. 5B. The pawl 20 is pivotably mounted on a pin 24 and configured to engage toothed element 22 such that in the forward configuration, driven element 6 is allowed to rotate freely in a forward direction but is substantially prevented from rotating in a reverse direction, and in the reverse configuration, driven element 6 is allowed to rotate freely in a reverse direction but is substantially prevented from rotating in a forward direction.

As best shown by FIGS. 5C and 3B, the bottom surface of tool body extension 23 includes a tenon-like ledge 26 configured to be received in a complementary mortise-like depression 28 on the top surface of tool body 4. When key element 16 is positioned in recessed cavity 14, detachment of the mortise-like joint formed between ledge surface 26 and depression 28 is substantially prevented, and toothed element 22 is configured to move in unison with tool body 4. When key element 16 is positioned in recessed cavity 14, longitudinal separation of tool body 4 from tool body extension 23 is likewise substantially prevented due to the abutment of a bottom edge of key element 16 against a top interior surface of toothed element 22. In alternative configurations, tool body 4 may be integrally formed with tool body extension 23 and optionally with toothed element 22. The tool body 4 and tool body extension 23 may be shaped as desired, and may include both cylindrical and non-cylindrical shapes.

Toothed element 22 includes a plurality of teeth 30 configured to engage with pawl 20. In some embodiments, as best shown by FIG. 5B, inwardly facing teeth 30 are provided on an inner periphery of toothed element 22. In this configuration, pawl 20 is configured to rotate with driven element 6. In other embodiments, outwardly facing teeth may be provided (e.g., on driven element 6), such that pawl 20 is configured to rotate with tool body 4. Such arrangements are well known in the art and are commonly used in ratcheting mechanisms including but not limited to roundhead ratchets. [0083] The ratcheting tool 2 shown in FIGS. 1 and 2 further includes first and second pawl supports 32 and 34, respectively, best shown by FIGS. 7A and 7B, between which pivotably mounted pawl 20 and a first biasing element, further described below, are sandwiched. As further described below, pawl supports 32 and 34 are configured to rotate in unison with driven element 6. As best shown by FIG. 7A, pawl supports 32 and 34 include a central bore 36 configured to receive driven element 6, and a semi-circular cutout 38 configured to receive key element 16. Pawl supports 32 and 34 further include three circular openings 40 arranged as shown in FIG. 7A. The opening 40 furthest from semi-circular cutout 38 is configured to receive pin 24 on which pawl 20 is pivotably mounted. The two remaining circular openings 40, adjacent to semi-circular cutout 38, are configured to receive a pair of cylindrical pins 42, best shown in FIGS. 9A-9C, that have a central portion of increased diameter relative to the diameters of the ends. In some embodiments, pins 42 are continuous, solid elements while in others, pins 42 are partially or substantially hollowed. Pawl supports 32 and 34 further include a pair of arcuate slots 44 disposed on opposite sides of central bore 36, which are configured to receive a pair of posts 46, best shown by FIGS. 10A and 10B.

The pawl 20 may be pivoted about pin 24 so as to engage or not engage teeth 30 of toothed element 22. The pawl 20 is controlled as further described below.

Ratcheting tool 2 shown in FIGS. 1 and 2 further includes a first biasing element coupled to ratchet mechanism 18 that is configured to bias ratchet mechanism 18 to at least one of the forward, reverse, and neutral positions. In some embodiments, as shown in FIGS. 11A-11B, the first biasing element is provided by an apical spring 48, the ends of which are looped around posts 46 and held thereon. The position of pawl 20 about pin 24 is controlled by spring 48, which includes a central portion 50, best shown by FIG. 11A, configured to bear directly on a rear surface of pawl 20. When spring 48 is rotated in a first direction in relation to the pawl, one end of pawl 20 is urged into contact with toothed element 22 to provide a ratcheting action in which tool body 4 is allowed to rotate freely in a first direction but is substantially prevented from rotating in an opposite direction on the backstroke. Conversely, when spring 48 is rotated in a second direction in relation to the pawl, the other end of pawl 20 is pressed into engagement with toothed element 22, thereby allowing tool body 4 to rotate freely in a second direction but substantially preventing it from rotating in an opposite direction on the backstroke. When the central portion 50 of spring 48 is centered with respect to the rear surface of pawl 20, spring 48 operates to hold pawl 20 in a neutral position, wherein pawl 20 is maintained out of contact with toothed element 22 and tool body 4 is allowed to free-wheel about the longitudinal axis L with respect to driven element 6.

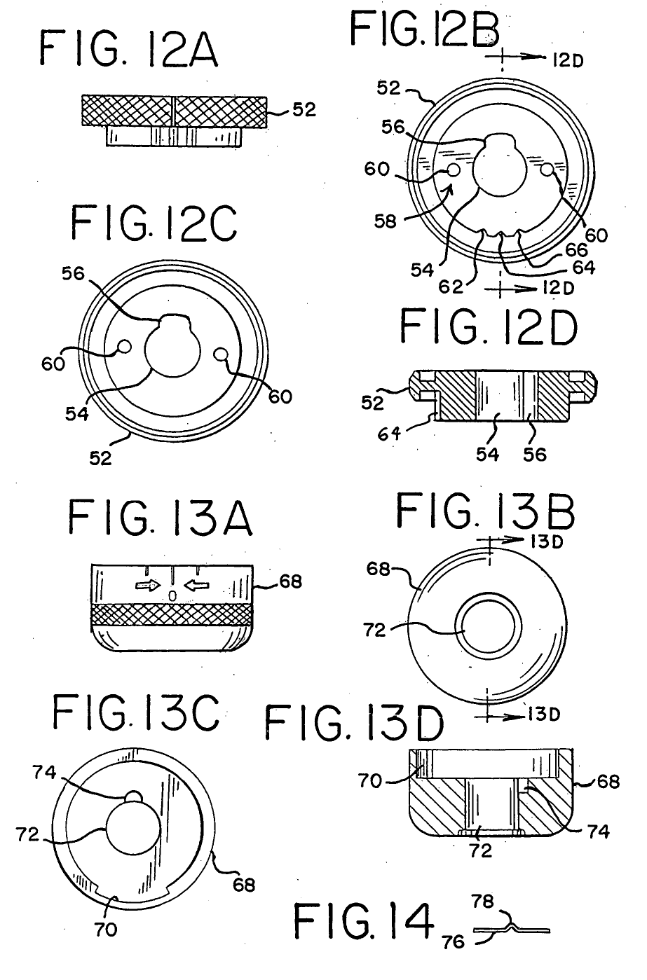

The ratcheting tool 2 shown in FIGS. 1 and 2 further includes a control element 52, best shown by FIGS. 12A-12D. Control element 52 includes a central bore 54 configured to receive driven element 6, and an obround cutout 56 configured to receive key element 16. When assembled, key element 16 protrudes slightly above obround cutout 56 on the top side 58 of control element 52, such that it is configured to engage with a control element retainer, as further described below. As best shown by FIGS. 12B and 12C, control element 52 further includes a pair of circular openings 60 disposed on either side of central bore 54, which are configured to receive posts 46 around which the ends of spring 48 are looped. Thus, when control element 52, first pawl support 32 and second pawl support 34 are assembled together with key element 16, the central portion 50 of spring 48 will be positioned to bear against a rear surface of pawl 20, thereby biasing pawl 20 towards forward, reverse or neutral ratcheting actions.

Control element 52 is rotatable with respect to driven element 6 about a limited arc. When control element 52 is rotated, posts 46 slide in arcuate slots 44 of the pawl supports 32 and 34, which limits the range of travel available to posts 46 during rotation of control element 52. In some embodiments, arcuate slots 44 are dimensioned to hold posts 46 out of substantial load-bearing contact with pawl support 32 and thereby to protect posts 46 from excessive shear loads.

In some embodiments, control element 52 further includes at least one, and in some embodiments, such as that shown in FIG. 12B, a plurality of outwardly facing notches. As shown in FIG. 12B, control element 52 includes first, second and third outwardly facing notches, 62, 64, and 66, respectively, each of which is configured to engage with a contact region of a second biasing element described below.

The ratcheting tool 2 shown in FIGS. 1 and 2 further includes a control element retainer 68 best shown by FIGS. 13A-13D. The control element retainer 68 is press-fit in place on driven element 6, such that there is substantially no rotational movement therebetween, or, for example, held in place with a ring clip. Control element retainer 68 includes an arcuate recess 70 in an inner side wall thereof that is configured to receive a second biasing element further described below. This second biasing element is configured to engage with first, second, and third notches, 62, 64, and 66, respectively. As best shown by FIG. 13C, control element retainer 68 includes a central bore 72 configured to receive driven element 6, and a semi-circular cutout 74 configured to receive the portion of key element 16 that protrudes beyond obround cutout 56.

The ratcheting tool 2 shown in FIGS. 1 and 2 further includes a second biasing element coupled to ratchet mechanism 18 that is configured to bias ratchet mechanism 18 to at least one of the forward, reverse, and neutral configurations. In some embodiments, as shown in FIG. 14, the second biasing element is provided by a spring 76 press fit into the arcuate recess 70 in control element retainer 68. The spring 76 includes a central portion 78 configured to bear on one of first, second and third outwardly facing notches, 62, 64, and 66, respectively. In this configuration, engagement of first notch 62 biases ratchet mechanism 18 to a first ratcheting configuration, engagement of second notch 64 biases ratchet mechanism 18 to the neutral configuration, and engagement of third notch 66 biases ratchet mechanism 18 to the second ratcheting configuration.

The above-described configuration of ratcheting tool 2 is designed such that rotation of tool body 4 rotates pawl 20, which rotates pin 24 on which pawl 20 is mounted, which rotates first and second pawl supports 32 and 34, respectively, in unison. By rotating control element 52, the direction of ratcheting action of ratcheting tool 2 may be controlled. As shown in FIG. 13A, indicial markings may optionally be provided on an exterior surface of control element retainer 68 to indicate the positions to which control element 52 should be shifted in order to engage one of the forward, neutral, and reverse ratcheting positions. Control element 52 may likewise be provided with an indicial marking, as shown in FIG. 12A, such that alignment of the mark on control element 52 with one of the marks on control element retainer 68 enables a user to easily locate a desired ratcheting position.

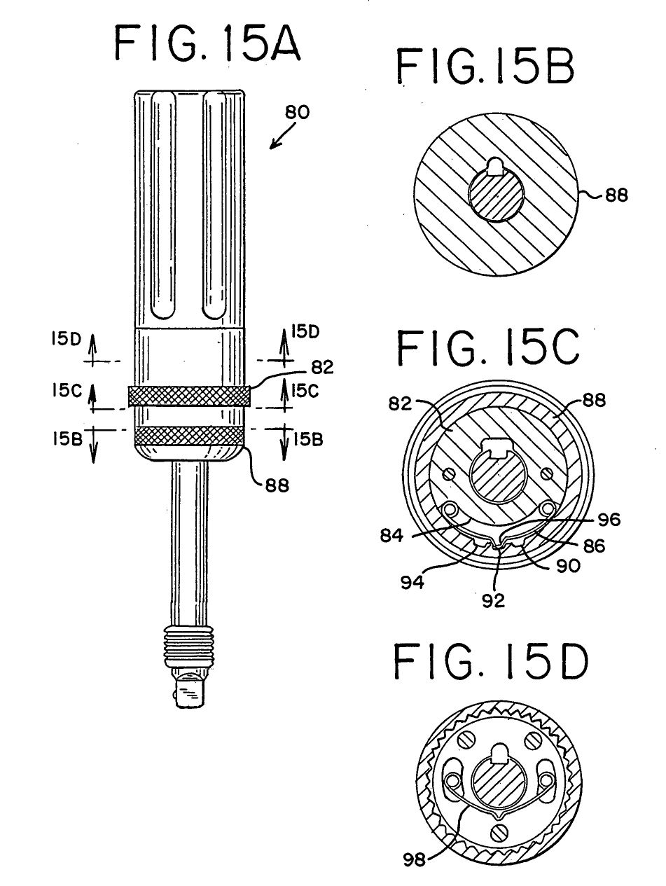

In the ratcheting tool 2 described above in reference to FIGS. 1-14, control element 52 includes a plurality of outwardly facing notches while control element retainer 68 includes spring 76 which serves as a second biasing element. However, in alternative embodiments, such as the representative example shown in FIGS. 15-17, the positions of the notches and second biasing element may be reversed.

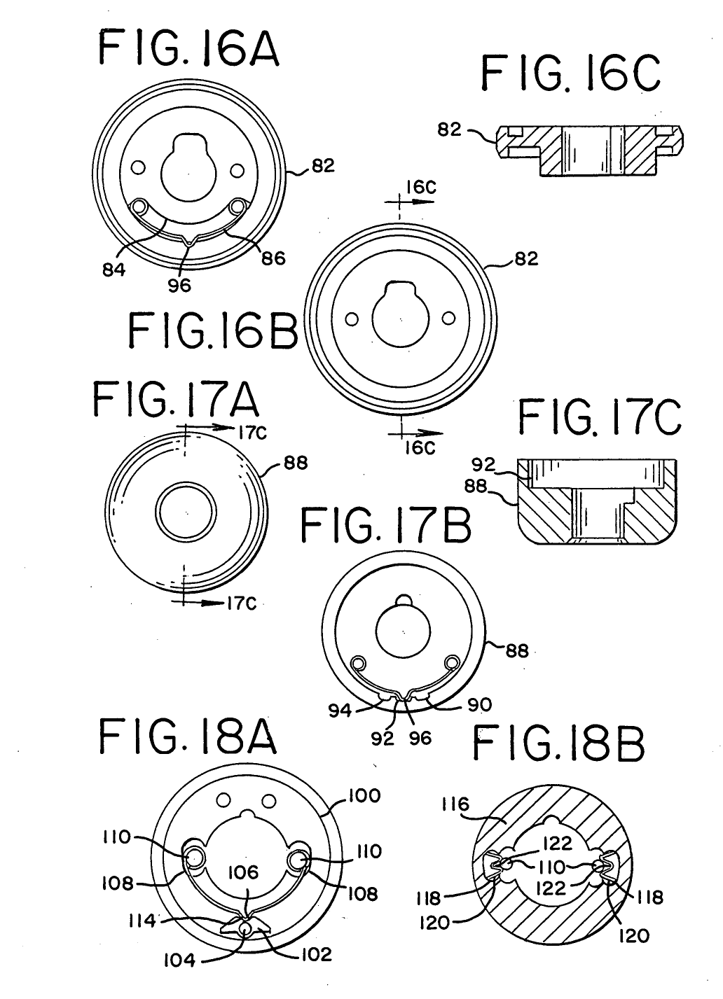

By way of example, a ratcheting tool 80 shown in FIG. 15A includes a control element 82 having an arcuate recess 84 configured to receive a second biasing element coupled to the ratchet mechanism, and to bias the ratchet mechanism to at least one of the forward, reverse, and neutral configurations. In some embodiments, as shown in FIGS. 15C and 16A, the second biasing element may be provided by an apical spring 86 press fit into arcuate recess 84. To complement this configuration, ratcheting tool 80 further includes a control element retainer 88, shown in FIGS. 15C and 17A, having first, second and third inwardly facing notches, 90, 92, and 94, respectively, each of which is configured to engage with a contact region 96 of spring 86.

FIG. 17B shows a bottom view of control element retainer 88 with spring 86 laid in to illustrate the manner of engaging inwardly facing notch 92 in accordance with this embodiment. The manner of retention of spring 86, not shown in FIG. 17B, is best shown by FIG. 16A as described above. As shown in FIG. 15D, the first biasing element configured to engage a pawl (not shown) of a ratcheting mechanism in a manner analogous to that described above in reference to FIGS. 1-14 is likewise provided by an apical spring 98. Thus, in the embodiment shown in FIGS. 15-17, both the first and second biasing elements, 98 and 86, respectively, are provided by apical springs.

In further alternative ratcheting tools in accordance with the present invention, a second biasing element may be provided that acts to bias the ratchet mechanism to only one of the three ratcheting positions—in a presently preferred configuration, to the neutral position. Ratcheting tools of this type may be provided by modifying the single-spring designs described in U.S. Pat. No. 6,182,536 to include a second biasing element. The entire contents of U.S. Pat. No. 6,182,536 are incorporated herein by reference, except that in the event of any inconsistent disclosure or definition from the present application, the disclosure or definition herein shall be deemed to prevail.

By way of example, FIGS. 18A and 18B show a bottom pawl support 100 containing a second biasing element, and in this representative example a pair of such biasing elements, configured for biasing a pawl 102 pivotably mounted on a pin 104 into the neutral position. A central depression 106 on a rear surface of pawl 102 corresponds to the neutral position of the ratcheting mechanism. As shown in FIG. 18A, pawl support 100 includes arcuate slots 108 configured to receive posts 110 that are slidable therein in a manner analogous to that described above in reference to FIGS. 1-14. The first biasing element is provided by an apical spring 112, the ends of which are looped around posts 110 and held thereon. The position of pawl 102 about pin 104 is controlled by spring 112, which includes a central portion 114, best shown by FIG. 18A, configured to bear directly on a rear surface of pawl 102. In this embodiment, pawl 102 and apical spring 112 are provided on the same side of pawl support 100.

As shown in FIG. 18B, the bottom surface 116 of pawl support 100 includes recessed cavities 118 configured to receive a second biasing element. In some embodiments, as shown in FIG. 18B, the second biasing element is provided by a pair of M-shaped springs 120 press fit into recessed cavities 118. In the neutral configuration, when central portion 114 of apical spring 112 is aligned and engaged with central depression 106 of pawl 102, the posts 110 will be substantially centrally positioned within arcuate slots 108, such that central valley portions 122 of M-shaped springs 120 are configured to engage and retain posts 110.

As described above and shown in FIG. 18A, pawl 102 includes a central depression 106 configured for engagement with spring 112. In alternative embodiments, the pawl is provided with first, second, and third notches, analogous to the pawls described in U.S. Pat. No. 6,182,536, which correspond to the forward, neutral, and reverse positions. A representative ratcheting tool incorporating these alternative pawls includes (a) a tool body; (b) a driven element, optionally containing a drive stud and/or socket; (c) a ratchet mechanism coupling the driven element to the tool body, wherein the ratchet mechanism is configured for adjustment between a plurality of a forward configuration, a reverse configuration, and a neutral configuration, and wherein the ratchet mechanism includes: a pawl and a toothed wheel, wherein the pawl is configured to engage the toothed wheel, and wherein the pawl comprises first, second, and third contact regions; (d) a first biasing element coupled to the ratchet mechanism and comprising a fourth contact region, wherein the fourth contact region is configured to engage at least one of the first, second, and third contact regions on the pawl, thereby biasing the ratchet mechanism to at least one of the forward, neutral, and reverse configurations, respectively; and (e) a second biasing element coupled to the ratchet mechanism and comprising a fifth contact region, wherein the second biasing element is configured to engage the ratchet mechanism with the fifth contact region and bias the ratchet mechanism to the neutral configuration when the first biasing element is engaged with the second contact region on the pawl.

In the various embodiments described above, the ratchet mechanisms for coupling the driven element to the tool body include a pawl and a toothed element. However, the present invention is not limited thereto. All manner of alternative ratchet mechanisms, and all equivalents thereto, may likewise be employed. Representative alternative ratchet mechanisms for use in accordance with the present invention include those that employ clutches (e.g., solid or fluid).

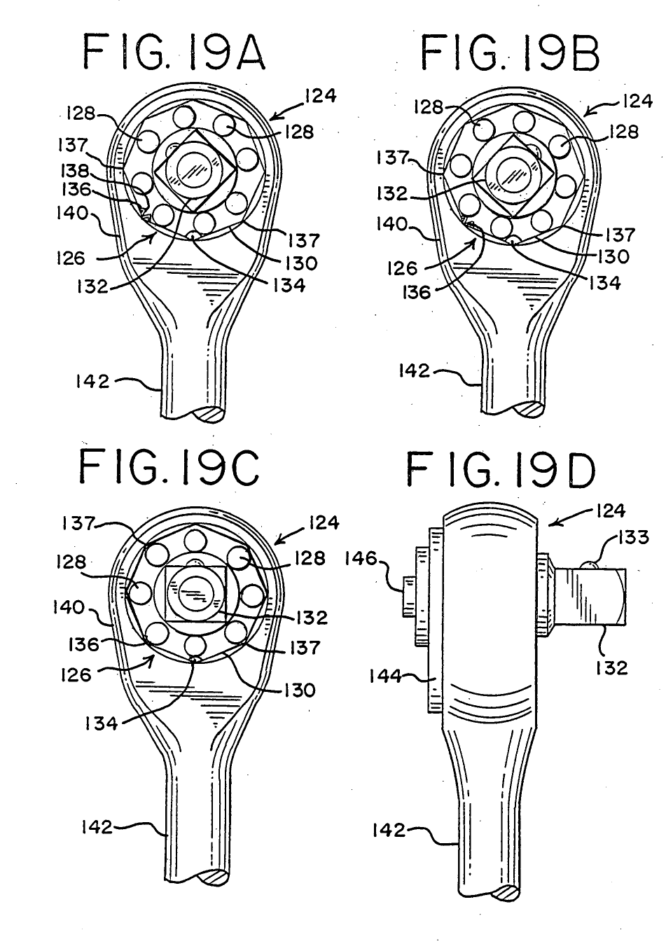

FIGS. 19A-19D show a fourth ratcheting tool 124 embodying features of the present invention. The ratcheting tool 124 includes a friction or clutch-type ratchet mechanism 126. Ratchet mechanism 126 contains a plurality of friction elements 128, for example, though not necessarily, substantially cylindrical pins, as shown in FIGS. 19A-19C, and an out-of-round collar 130, which may be octagonally shaped as further shown in FIGS. 19A-19C. The friction elements 128 are interposed between a driven element 132 and out-of-round collar 130. Alternative shapes for out-of-round collar 130 may likewise be employed, including but not limited to hexagonal shapes, heptagonal shapes, and the like.

Friction elements 128 are configured to engage driven element 132, which may include a drive stud as shown in FIGS. 19A-19D. As best shown by FIG. 19D, driven element 132 may be provided with a detent mechanism 133 for releasably engaging a workpiece (not shown), such as a socket. In the forward configuration, driven element 132 is allowed to rotate freely in a forward direction but is substantially prevented from rotating in a reverse direction. In the reverse configuration, driven element 132 is allowed to rotate freely in the reverse direction but is substantially prevented from rotating in the forward direction.

Ratcheting tool 124 further includes at least one first biasing element, which may be provided by a detent element 134, as best shown by FIGS. 19A-19C. Detent element 134 is configured for bearing against at least one of friction elements 128 and, in some embodiments, detent element 134 is substantially cone-shaped.

Ratcheting tool 124 further includes at least one second biasing element, which may be provided by a spring 136 mounted in a recess (not shown) in tool head 140, wherein the spring 136 has a contact region 138 configured to receive at least one of the plurality of friction elements 128. As best shown by FIGS. 19A and 19B, spring 136 may be M-shaped, with the central valley of the M being aligned with a vertex 137 of out-of-round collar 130. In a neutral position, spring 136 is configured to receive an adjacent friction element 128 in its central valley portion and to retain this friction element in a manner analogous to that described above in reference to M-shaped spring 120. When the friction element 128 adjacent to spring 136 moves from one side of its corresponding vertex to the other side (e.g., when the ratcheting direction is changed from forward to reverse or vice versa), spring 136 is configured to recede and/or deform into the recess (not shown) in tool head 140 so as not to substantially impede the movement of friction element 128.

The ratcheting direction of ratcheting tool 124 may be controlled by moving a reversing lever 144 located on the rear surface of the tool head 140 from one side to the other. The detent mechanism 133 in driven element 132 may be controlled by a push button 146 adjacent to reversing lever 144.

As shown in FIGS. 19A-19C, out-of-round collar 130 includes a plurality of vertices 137 at least equal in number to the plurality of friction elements 128. Friction elements 128 are positioned slightly to one side of their respective vertices 137 in a forward configuration, as shown in FIG. 19A, slightly to the other side of their respective vertices 137 in the reverse configuration, as shown in FIG. 19B, and substantially in alignment with their respective vertices 137 in the neutral configuration, as shown in FIG. 19C.

Friction elements 128 are rolled from one side of their respective vertices 137 to the other when the reversing lever 144 coupled thereto is moved accordingly. As shown in FIG. 19C, detent element 134 is forced inside tool body 142 by an adjacent friction element 128 when ratcheting tool 124 is in the neutral position, such that driven element 132 is allowed to free wheel with respect to head 140 of tool body 142. The stability of this neutral position is increased through the agency of M-shaped spring 136, which receives and retains an adjacent friction element 128 in its central valley portion. In alternative embodiments to the representative example shown in FIGS. 19A-19C, ratcheting tool 124 may optionally be provided with a plurality (i.e., two or more) springs 136 configured to receive separate friction elements 128, and/or with two or more detent elements 134 likewise configured to bias separate friction elements 128. In other embodiments, detent element 134 may be omitted and replaced by one or more springs 136.

Ratcheting tools in accordance with the present invention may further include a quick release mechanism, such as the one described in U.S. Pat. No. 6,182,536, incorporated by reference in its entirety above. For example, as shown in FIG. 1, ratcheting tool 2 includes a quick release mechanism 148 that is particularly simple and inexpensive to assemble. The illustrated quick release mechanism 148 includes a pin (not shown) that slides in an oblique passageway, as shown and described in the above-referenced patent. As further described therein, the pin is biased in a selected direction by a spring that bears on a ring that in turn bears on the pin. The ring (not shown) is symmetrical about its own plane, and thus the ring may be assembled in either orientation and still perform its function properly. This eliminates the need to orient the ring in a selected orientation at the time, of assembly, and thereby simplifies assembly.

The quick release mechanism 148 is in many respects similar to the quick release mechanism described in U.S. Pat. No. 5,644,958, assigned to the assignee of the present invention, the entire contents of which are incorporated herein by reference, except that in the event of any inconsistent disclosure or definition from the present application, the disclosure or definition herein shall be deemed to prevail. As shown and described in greater detail in U.S. Pat. No. 5,644,958, the quick release mechanism 148 may include a locking element which in some embodiments takes the form of a pin. The pin slides in a passageway 150 in driven element 6, best shown by FIG. 4C, that is obliquely oriented with respect to the longitudinal axis L and extends between openings in the out-of-round drive portion 13 and adjacent portion 11 of driven element 6. As further described in the above-referenced patents, the pin may include a first end at the out-of-round drive portion 13 and a second end at the adjacent portion 11. The pin is movable in passageway 150 between a tool attachment engaging position wherein the first end of the pin is positioned to engage a tool attachment, such as a socket, to hold the tool attachment in place on drive portion 13. The alternate position is a tool attachment releasing position analogous to that shown in U.S. Pat. No. 5,644,958 wherein the first end of the pin is received substantially within passageway 150 and the tool attachment is released from drive portion 13. In the embodiment described, the pin is biased away from the out-of-round drive portion 13 by a releasing spring. However, alternative quick release mechanisms may be employed with equal ease.

The position of the pin in passageway 150 is controlled by an actuator 152, shown in FIG. 1. In some embodiments, actuator 152 includes a ring biased against the pin by an engaging spring as described in the above-referenced patents. The ring may be lifted away from the drive portion 13 (e.g., upwardly in the orientation shown in FIG. 1) by a collar that defines a ledge that engages the ring. When no external forces are applied to actuator 152, the spring presses the ring against the pin with sufficient force to compress a second spring mounted around the pin to move the first end of the pin outwardly to the tool attachment engaging position.

From the foregoing, it will be readily apparent that a ratcheting tool has been discovered that has improved stability in its neutral position as compared to tools that contain only a single multi-functional biasing element. A control element, reversing lever or the like may be used to set the ratchet mechanism of tools in accordance with the present invention for clockwise ratcheting action, counterclockwise ratcheting action, or free-wheeling. When clockwise or counterclockwise ratcheting action is selected, the tool body may be used manually to tighten or loosen a fastener with a tool attachment such as a hex tool, a torx tool, a socket-mounted screwdriver bit (e.g., slotted, Phillips or torx) or a socket attached to a drive stud. When the ratchet mechanism is positioned in the freewheeling position, the freewheeling tool body may be used as a guide to steady the driven element as it is being rotated by a conventional tool (e.g., a socket wrench) engaged with one of the coupling ends (e.g., a drive socket).

The foregoing detailed description and accompanying drawings have been provided solely by way of explanation and illustration, and are not intended to limit the scope of the appended claims. Many variations in the presently preferred embodiments illustrated herein will be obvious to one of ordinary skill in the art, and remain within the scope of the appended claims and their equivalents.

1. A ratcheting tool comprising:
a tool body;
a driven element;
a ratchet mechanism coupling the driven element to the tool body, wherein the ratchet mechanism is configured for adjustment between a plurality of a forward configuration, a reverse configuration, and a neutral configuration;
an adjustable first biasing element coupled to the ratchet mechanism and configured to bias the ratchet mechanism to at least one of the forward, reverse, and neutral configurations; and
an adjustable second biasing element coupled to the ratchet mechanism and configured to bias the ratchet mechanism to at least one of the forward, reverse, and neutral configurations.

2. The invention of claim 1 wherein the first biasing element is configured to bias the ratchet mechanism to a plurality of the forward, reverse, and neutral configurations.

3. The invention of claim 1 or 2 wherein the first and second biasing elements bias the ratchet mechanism concertedly to at least one of the forward, reverse, and neutral configurations.

4. The invention of claim 1 or 2 wherein the first and second biasing elements do not concertedly bias the ratchet mechanism to at least one of the forward, reverse, and neutral configurations.

5. The invention of claim 1 or 2 wherein the ratchet mechanism comprises a pawl and a toothed element, wherein the pawl is configured to engage the toothed element such that:
in the forward configuration, the driven element is allowed to rotate freely in a forward direction but is substantially prevented from rotating in a reverse direction; and
in the reverse configuration, the driven element is allowed to rotate freely in the reverse direction but is substantially prevented from rotating in the forward direction.

6. The invention of claim 1 or 2 wherein the first biasing element comprises a spring configured to bear against a surface of a pawl.

7. The invention of claim 5 wherein the toothed element comprises inwardly facing teeth provided on an inner periphery of the tool body, and wherein the pawl is configured to rotate with the driven element.

8. The invention of claim 5 wherein the toothed element comprises outwardly facing teeth provided on the driven element, and wherein the pawl is configured to rotate with the tool body.

9. The invention of claim 1 or 2 wherein the ratcheting tool further comprises a control element coupled to the ratchet mechanism, wherein the control element comprises at least one notch configured to engage with the second biasing element, such that engagement biases the ratchet mechanism to at least one of the forward, neutral, and reverse configurations.

10. The invention of claim 1 or 2 wherein the ratcheting tool further comprises a control element coupled to the ratchet mechanism, wherein the control element comprises first, second and third notches, each of which is configured to engage with the second biasing element, such that engagement of the first notch biases the ratchet mechanism to the forward configuration, engagement of the second notch biases the ratchet mechanism to the neutral configuration, and engagement of the third notch biases the ratchet mechanism to the reverse configuration.

11. The invention of claim 1 or 2 wherein the ratcheting tool further comprises a control element retainer comprising a recess configured to receive the second biasing element.

12. The invention of claim 1 or 2 wherein the second biasing element comprises a spring configured to bear against a surface of a notch.

13. The invention of claim 10 wherein the second biasing element comprises a spring configured to bear against a surface of the first, second, and third notches.

14. The invention of claim 1 or 2 wherein the driven element comprises a first coupling end selected from the group consisting of a drive stud and a socket, and a second coupling end selected from the group consisting of a drive stud and a socket.

15. The invention of claim 1 or 2 wherein the ratcheting tool further comprises a control element coupled to the ratchet mechanism, wherein the control element comprises a recess configured to receive the second biasing element.

16. The invention of claim 15 wherein the ratcheting tool further comprises a control element retainer comprising at least one notch configured to engage with the second biasing element, such that engagement biases the ratchet mechanism to the neutral configuration.

17. The invention of claim 15 wherein the ratcheting tool further comprises a control element retainer comprising first, second and third notches, each of which is configured to engage with the second biasing element, such that engagement of the first notch biases the ratchet mechanism to the forward configuration, engagement of the second notch biases the ratchet mechanism to the neutral configuration, and engagement of the third notch biases the ratchet mechanism to the reverse configuration.

18. The invention of claim 17 wherein the second biasing element comprises a spring configured to bear against a surface of the first, second, and third notches.

19. The invention of claim 1 or 2 wherein the second biasing element comprises an M-shaped spring, such that a central valley portion thereof provides a contact region.

20. The invention of claim 1 or 2 wherein the ratchet mechanism comprises a plurality of friction elements and an out-of-round collar, wherein the friction elements are configured to engage the driven element such that:
in the forward configuration, the driven element is allowed to rotate freely in a forward direction but is substantially prevented from rotating in a reverse direction; and
in the reverse configuration, the driven element is allowed to rotate freely in the reverse direction but is substantially prevented from rotating in the forward direction.

21. The invention of claim 20 wherein the first biasing element comprises a detent element configured for biasing at least one of the friction elements.

22. The invention of claim 21 wherein the detent element is substantially cone-shaped.

23. The invention of claim 21 wherein each of the friction elements comprises a substantially cylindrical pin.

24. The invention of claim 20 wherein the second biasing element comprises a spring configured to engage one of the plurality of friction elements, such that in the neutral configuration, the driven element is allowed to free wheel with respect to the tool body.

25. The invention of claim 20 wherein the friction elements are interposed between the driven element and the out-of-round collar:

26. The invention of claim 20 wherein the out-of-round collar comprises a plurality of vertices at least equal in number to the plurality of friction elements, and wherein the plurality of friction elements are positioned to one side of the respective vertices in the forward configuration, to the other side of the respective vertices in the reverse configuration, and substantially in alignment with the respective vertices in the neutral configuration.

27. A ratcheting tool comprising:
a tool body;
a driven element comprising a drive stud;
a ratchet mechanism coupling the driven element to the tool body, wherein the ratchet mechanism is configured for adjustment between a forward configuration, a reverse configuration, and a neutral configuration, and wherein the ratchet mechanism comprises:
a toothed element and a pawl configured to engage the toothed element;
a first biasing element coupled to the ratchet mechanism and configured to bias the ratchet mechanism to at least one of the forward, neutral, and reverse configurations;
a second biasing element coupled to the ratchet mechanism and configured to bias the ratchet mechanism to at least one of the forward, neutral, and reverse configurations;
a control element coupled to the ratchet mechanism and comprising first, second and third notches, each of which is configured to engage with the second biasing element, such that engagement of the first notch biases the ratchet mechanism to the forward configuration, engagement of the second notch biases the ratchet mechanism to the neutral configuration, and engagement of the third notch biases the ratchet mechanism to the reverse configuration; and
a control element retainer coupled to the control element, wherein the control element retainer comprises a recess configured to receive the second biasing element.

28. The invention of claim 27 wherein the first biasing element comprises a spring comprising a central portion configured to bear against a surface of the pawl.

29. The invention of claim 28 wherein the second biasing element comprises a spring comprising a central portion configured to bear against a surface of the first, second, and third notches.

30. A ratcheting tool comprising:
a tool body;
a driven element comprising a drive stud;
a ratchet mechanism coupling the driven element to the tool body, wherein the ratchet mechanism is configured for adjustment between a forward configuration, a reverse configuration, and a neutral configuration, and wherein the ratchet mechanism comprises:
a toothed element and a pawl configured to engage the toothed element;
a first biasing element coupled to the ratchet mechanism and configured to bias the ratchet mechanism to at least one of the forward, neutral, and reverse configurations;
a second biasing element coupled to the ratchet mechanism and configured to bias the ratchet mechanism to at least one of the forward, neutral, and reverse configurations;
a control element coupled to the ratchet mechanism, wherein the control element comprises a recess configured to receive the second biasing element; and
a control element retainer comprising first, second and third notches, each of which is configured to engage with the second biasing element, such that engagement of the first notch biases the ratchet mechanism to the forward configuration, engagement of the second notch biases the ratchet mechanism to the neutral configuration, and engagement of the third notch biases the ratchet mechanism to the reverse configuration.

31. The invention of claim 27 or 30 wherein the first, second, and third notches correspond, respectively, to forward, neutral, and reverse ratcheting configurations.

32. The invention of claim 1 or 2 further comprising a handle.

33. The invention of claim 32 wherein the handle is at a right angle to a longitudinal axis of the driven element.

34. The invention of claim 32 wherein the handle is moveable between a plurality of angles with respect to the longitudinal axis of the driven element.

35. A ratcheting tool comprising:
a tool body;
a driven element;
a ratchet mechanism coupling the driven element to the tool body, wherein the ratchet mechanism is configured for adjustment between a plurality of a forward configuration, a reverse configuration, and a neutral configuration;
an adjustable first biasing element coupled to the ratchet mechanism and configured to bias the ratchet mechanism to at least one of the forward, reverse, and neutral configurations; and
an adjustable second biasing element coupled to the ratchet mechanism and configured to bias the ratchet mechanism to at least one of the forward, reverse, and neutral configurations;
wherein at least one of the first biasing element and the second biasing element is configured to bias the ratchet mechanism to the neutral configuration.

36. The invention of claim 35 wherein the ratchet mechanism comprises a pawl and a toothed element, wherein the pawl is configured to engage the toothed element such that:
in the forward configuration, the driven element is allowed to rotate freely in a forward direction but is substantially prevented from rotating in a reverse direction; and
in the reverse configuration, the driven element is allowed to rotate freely in the reverse direction but is substantially prevented from rotating in the forward direction.

37. The invention of claim 35 wherein the first biasing element comprises a spring configured to bear against a surface of a pawl.

38. The invention of claim 36 wherein the toothed element comprises inwardly facing teeth provided on an inner periphery of the tool body, and wherein the pawl is configured to rotate with the driven element.

39. The invention of claim 36 wherein the toothed element comprises outwardly facing teeth provided on the driven element, and wherein the pawl is configured to rotate with the tool body.

40. The invention of claim 35 wherein the ratcheting tool further comprises a control element coupled to the ratchet mechanism, wherein the control element comprises at least one notch configured to engage with the second biasing element, such that engagement of the at least one notch biases the ratchet mechanism to the neutral configuration.

41. The invention of claim 35 wherein the ratcheting tool further comprises a control element coupled to the ratchet mechanism, wherein the control element comprises first, second and third notches, each of which is configured to engage with the second biasing element, such that engagement of the first notch biases the ratchet mechanism to the forward configuration, engagement of the second notch biases the ratchet mechanism to the neutral configuration, and engagement of the third notch biases the ratchet mechanism to the reverse configuration.

42. The invention of claim 35, 36, 40 or 41 wherein the ratcheting tool further comprises a control element retainer comprising a recess configured to receive the second biasing element.

43. The invention of claim 35, 36, 40 or 41 wherein the second biasing element comprises a spring configured to bear against a surface of a notch.

44. The invention of claim 41 wherein the second biasing element comprises a spring configured to bear against a surface of the first, second, and third notches.

45. The invention of claim 35 wherein the driven element comprises a first coupling end selected from the group consisting of a drive stud and a socket, and a second coupling end selected from the group consisting of a drive stud and a socket.

46. The invention of claim 35 wherein the ratcheting tool further comprises a control element coupled to the ratchet mechanism, wherein the control element comprises a recess configured to receive the second biasing element.

47. The invention of claim 35 or 46 wherein the ratcheting tool further comprises a control element retainer comprising at least one notch configured to engage with the second biasing element, such that engagement biases the ratchet mechanism to the neutral configuration.

48. The invention of claim 35 or 46 wherein the ratcheting tool further comprises a control element retainer comprising first, second and third notches, each of which is configured to engage with the second biasing element, such that engagement of the first notch biases the ratchet mechanism to the forward configuration, engagement of the second notch biases the ratchet mechanism to the neutral configuration, and engagement of the third notch biases the ratchet mechanism to the reverse configuration.

49. The invention of claim 48 wherein the second biasing element comprises a spring configured to bear against a surface of the first, second, and third notches.
